(19) United States
(12) Patent Application Publication
(10) Pub. No.: US 2005/0148347 A1
(43) Pub. Date: Jul. 7, 2005

(54) Wireless communication system

(76) Inventor: Kazuyoshi Nagai, Kawasaki (JP)

Correspondence Address: KATTEN MUCHIN ROSENMAN LLP, 575 MADISON AVENUE, NEW YORK, NY, 10022-2585, US

(21) Appl. No.: 11/075,279

(22) Filed: Mar. 7, 2005

Related U.S. Application Data
(63) Continuation of application No. PCT/JP03/04010, filed on Mar. 28, 2003.

(51) Int. Cl. H04Q 7/20

(52) U.S. Cl. 455/456.6; 455/456.5

(57) ABSTRACT

A Dario communication system including base stations that distribute predetermined data by radio so as to be received by mobile terminals located within the communication area of a base station. This system comprises a management unit managing communication area information on the communication area of each of the base stations, a communication area information providing server to which the communication area information is sent from each of the base stations a mobile terminal that has, a radio communication unit for receiving communication area information sent from each of the base stations depending on the position of the mobile terminal and boots up an application program to be used in the communication area which the mobile terminal approaches according to this received communication area information.

### BACKGROUND OF THE INVENTION

The present invention relates to a technology pertaining to a DSRC (Dedicated Short Range Communications) defined as a wireless communication system used for an ITS (Intelligent Transport Systems), etc.

The DSRC is a system aiming at an on-traveling/under-stoppage mobile terminal and enabling a user to utilize a variety of services mainly via an on-vehicle device mounted on a vehicle and via an HMI (Human Machine Interface) within a (short range) wireless communication area (ranging from approximately several meters to several tens of meters) provided spotwise by the base station installed on a road side.

At the present, the DSRC is actually operated as an ETC (Electronic Toll Collection) system, wherein the user attaches an ETC-dedicated on-vehicle device to a vehicle, and this system is utilized for automatically collecting and receiving tolls for toll highways. It will be expected from now on that the DSRC serves as the wireless communication system capable of providing multi-services such as a traffic information providing service, a peripheral area information providing service, a parking area utilizing service, payment of charges at a convenience store, a gasoline station, etc., Internet services and so forth.

What is required at this time is a mobile terminal such as a [general-purpose on-vehicle device], etc. that can support the multi-services in terms of an installation space, a cost, etc.

As stated above, the DSRC system has hitherto been an ETC (single) service (system) using the ETC-dedicated on-vehicle device. Therefore, requirements for the on-vehicle device and for the system are given as follows.

Implementation application: [only ETC] (No necessity for supporting a plurality of applications). Wireless line: Modulation method is ASK/1 Mbps (one type), and the frequency is 2 waves (search and selection are needed). Communication area: Installation locations are an entrance and an exit of a tollgate, and there is a necessity of notifying the user of an ETC lane.

The ETC on-vehicle device in linkage with a car navigation system is given as a specific conventional example (refer to, e.g., Patent document 1).

Patent Document 1

Japanese Patent Application Laid-Open Publication No. 2001-134794

In this on-vehicle device, when approaching,the ETC lane, an on-approaching tollgate information (showing a location of the ETC lane) and frequency information (any one of 2 waves of Ach and Bch) that should be used in the lane, are obtained from the car navigation system that is underway to detect the position of the user's car itself. This enables the user to be guided (led) via the HMI to the ETC lane (the communication area), eliminates a circuit and software (there is no necessity for a process (time) of selecting the frequency when entering the area) for searching for the frequency which requires high-speed processing in order to set in a radio a frequency value that should be used in that area before entering the area, and also enables the communications to be performed with no futility within the area.

Further, the tollgate information and the frequency information provided from the car navigation system are stored together with map information as pieces of information linked to electronic map data, and are therefore not easy to update.

As described above, the prior arts provide the system for actualizing the ETC single service and the dedicated on-vehicle device. In the case of applying multi-applications to the DSRC system from now on, however, there arises the following problem that can not be dealt with by the prior arts.

Namely, in the case of applying the multi-applications to the DSRC system, there must be a plurality of application programs loaded into the on-vehicle device, and hence a lack of resources is presumed as a load on the CPU increases due to congestion between the application programs.

### BRIEF SUMMARY OF THE INVENTION

It is an object of the present invention to provide a technology for efficiently utilizing resources in order to restrain an increase in scale of hardware.

The present invention is, for obviating the above problem, a wireless communication system including a plurality of base stations for wirelessly distributing predetermined data for the purpose of being received by a mobile terminal located within a communication area of the system itself, the system comprising management unit managing communication area information about communication areas of the respective base stations, a communication area information providing server distributing the communication area information distributed via each of the base stations, and a mobile terminal having a wireless communication unit for receiving the communication area information distributed from each of the base stations in accordance with a self-position, and starting up an application program that should be used in the communication area that the mobile terminal itself approaches based on the received communication area information.

According to the present invention, only an application program that should be used in the communication area the mobile terminal approaches, is automatically started up, and hence the resources can be efficiently utilized.

Further, in the wireless communication system, for instance, the mobile terminal starts up the application program before arriving at the communication area that the mobile terminal itself approaches.

With this contrivance, the application program can be started up before arriving at the communication area that the mobile terminal approaches.

In the wireless communication system, for example, the mobile terminal sets, in the wireless communication unit, a communication parameter that should be used in the communication area the mobile terminal itself approaches.

With this contrivance, even when the wireless line is diversified (e.g., an increase in channel of frequency), it is possible to properly select or designate the wireless line.

Further, in the wireless communication system, for instance, the mobile terminal sets the communication parameter before arriving at the communication area that the mobile terminal itself approaches.

With this contrivance, the communication parameter can be set before the mobile terminal approaches the communication area.

Moreover, in the wireless communication system, for example, the mobile terminal stops the running application. For instance, in the case of passing through the communication area that the mobile terminal approaches, the application is stopped or finished.

With this contrivance, the resources can be efficiently used.

Further, in the wireless communication system, for instance, the communication area information providing server distributes the communication area information about at least the communication areas in the vicinity of the communication area of a distribution source base station, distributed from each of the base stations.

With this contrivance, the user can promptly utilize the want-to-utilize service in the vicinity of the present position.

In the wireless communication system, for example, the communication area information providing server distributes the communication area information about at least the communication areas of base stations for providing the same category of service, distributed from each of the base stations.

With this contrivance, the user can grasp the locations, etc. of the base stations for providing the same service.

In the wireless communication system, for example, the communication area information providing server distributes the communication area information about at least the communication area within a district corresponding to a user designated position, distributed from each of the base stations.

With this contrivance, the user can obtain the desired communication area information.

Moreover, the present invention can be specified as a mobile terminal as follows.

A mobile terminal included in a wireless communication system including a plurality of base stations for wirelessly distributing predetermined data for the purpose of being received by a mobile terminal located within a communication area of the system itself, comprises a wireless communication unit receiving communication area information distributed from each of the base stations in accordance with a self-position, a storage unit storing the communication area information received by the wireless communication unit, a determining unit determining an application program that should be used in the communication area that the mobile terminal itself approaches based on the communication area information stored on the storage unit, and a program starting unit for starting up the application program determined by the determining unit.

In the mobile terminal, for instance, the program staring unit starts up the application program before arriving at the communication area that the mobile terminal itself approaches.

For example, the mobile terminal further comprises a setting unit for setting, in the wireless communication unit, a communication parameter that should be used in the communication area that the mobile terminal itself approaches.

In the mobile terminal, for instance, the setting unit sets the communication parameter before arriving at the communication area that the mobile terminal itself approaches.

The present invention can be specified as a communication area information providing server as follows.

A communication area information providing server included in a wireless communication system including a plurality of base stations for wirelessly distributing predetermined data for the purpose of being received by a mobile terminal located within a communication area of the system itself, comprises a management unit managing communication area information about communication areas of the respective base stations, and a distributing unit distributing the communication area information via each of the base stations.

Further, the present invention can be specified as the invention of a program and the invention as a storage medium stored with the program.

### BRIEF DESCRIPTION OF THE DRAWINGS

FIG. 1A and FIG. 1B are explanatory diagrams showing an outline of system architecture of a wireless communication system by way of an embodiment of the present invention;

FIG. 2 is an explanatory diagram showing a layout example of communication areas of respective base stations;

FIG. 3 is a partially enlarged perspective view in FIG. 2 and is an explanatory view showing in detail the layout example of the base stations and of the communication areas thereof;

FIG. 4 is an explanatory diagram showing an example of communication area information;

FIG. 5 is an explanatory diagram showing an example of user information;

FIG. 6A and FIG. 6B are explanatory flowchart showing an operation of the wireless communication system in the present embodiment; and

FIG. 7 is an explanatory flowchart showing the operation of the wireless communication system in the present embodiment.

### DETAILED DESCRIPTION OF THE INVENTION

A wireless communication system (which is also termed a multi-application DSRC system) will hereinafter be described by way of an embodiment of the present invention with reference to the drawings.

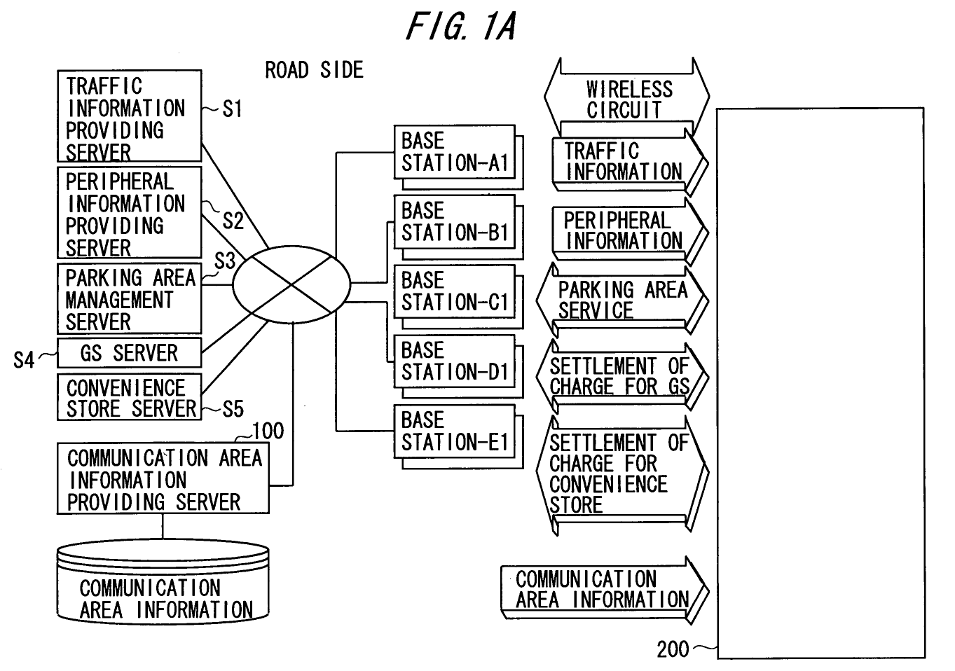

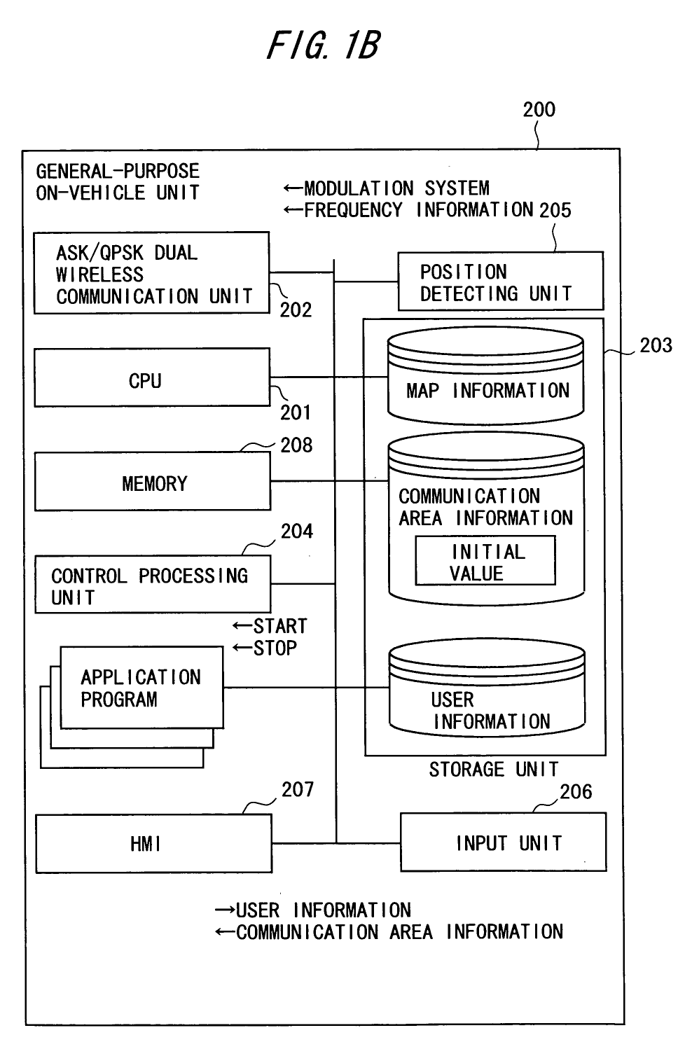

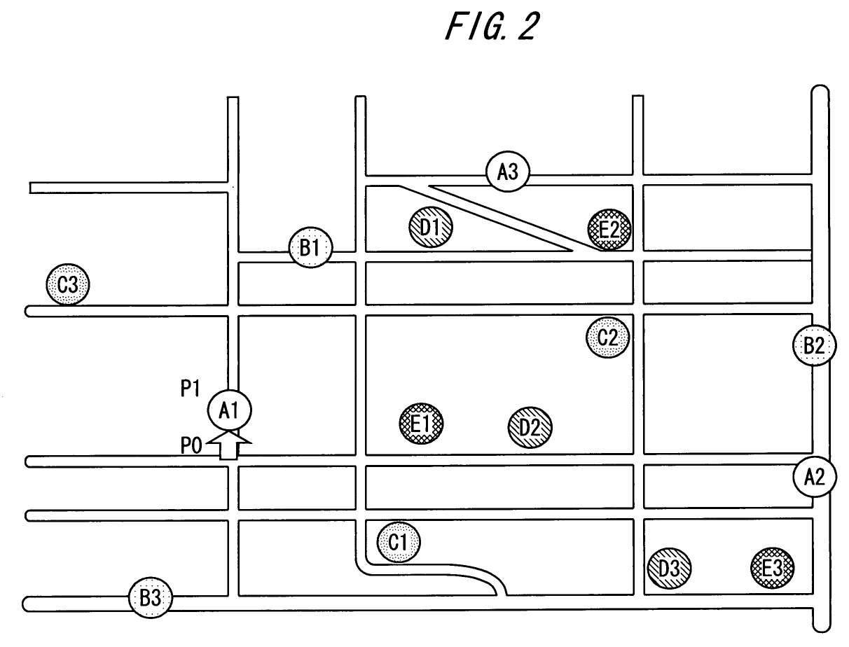

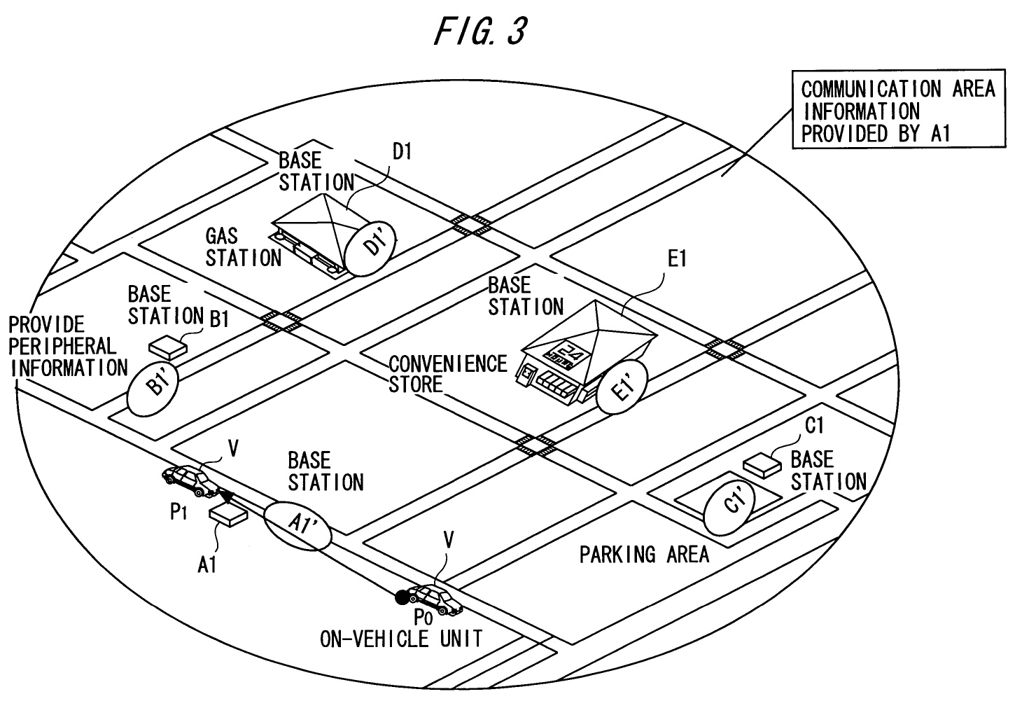

FIG. 1A and FIG. 1B are explanatory diagram showing an outline of a system architecture of a wireless communication system by way of the embodiment of the present invention. FIG. 2 is an explanatory diagram showing a layout example of communication areas of respective base stations. FIG. 3 is a partially enlarged perspective view in FIG. 2 and is an explanatory view showing in detail the layout example of the base stations and of the communication areas thereof.

(Outline of System Architecture of Wireless Communication System)

As shown in FIG. 1A and FIG. 1B, the wireless communication system in the present embodiment includes a plurality of base stations (A1-Al, B1-Bm, C1-Cn, D1-Dp, E1-Eq), a communication area information providing server 100, a mobile terminal 200 and a variety of information providing servers S1 through S5.

The respective base stations (A1-Al, B1-Bm, C1-Cn, D1-Dp, E1-Eq) serve to provide (distribute, transmit or multicast) predetermined data (such as data about predetermined services, communication area information, etc.) for the purpose that the mobile terminals 200 located within their own communication areas receive the predetermined data.

Communication areas (A1′-Al′, B1′-Bm′, C1′-Cn′, D1′-Dp′, E1′-Eq′) of the respective base stations are provided spotwise in a DSRC-based wireless communication system (see. FIGS. 2 and 3). The communication areas will hereinafter be denoted by affixing (′) to the symbols representing the base stations corresponding thereto. For example, the communication area of the base station A1 is denoted such as the communication area A1′. The same notation is applied to others.

As shown in FIGS. 2 and 3, the respective base stations (A1-Al, B1-Bm, C1-Cn, D1-Dp, E1-Eq) are installed on road sides such as road shoulders, etc. For instance, the base stations A1-Al and B1-Bm are installed on the road shoulders. The base stations C1-Cn are installed within parking areas. The base stations D1-Dp are installed in gasoline stations GS. The base stations E1-Eq are installed in parking spaces of convenience stores.

As shown in FIG. 1A and FIG. 1B, the variety of information providing servers S1-S5 such as a traffic information providing server, etc. and the communication area information providing server 100 are connected to the respective base stations (A1-Al, B1-Bm, C1-Cn, D1-Dp, E1-Eq) via a network such as the Internet, a public telephone line network, etc., or a telecommunications line, etc. such as a dedicated (private) line, etc.

The respective base stations (A1-Al, B1-Bm, C1-Cn, D1-Dp, E1-Eq) distribute the data about the predetermined services supplied from the variety of information providing servers S1-S5 via their networks, etc. For example, the base stations A1-Al provide a traffic information providing service (data, etc. about traffic information) supplied from a traffic information providing servers 1. The base stations B1-Bm provide a peripheral information providing service (data, etc. about peripheral information) supplied from a peripheral information providing server S2. The base stations C1-Cn provide a parking area utilizing service (data, etc. about the parking areas) supplied from a parking area management server S3. The base stations D1-Dp provide a GS utilizing service (data, etc. about the gasoline stations GS) supplied from a GS server S4. The base stations E1-Eq provide a convenience store utilizing service (data, etc. about the convenience stores) supplied from a convenience store server S5.

The communication area information providing server 100 serves to supply the respective base stations (A1-Al, B1-Bm, C1-Cn, D1-Dp, El-Eq) mainly with the communication area information about the communication areas of the respective base stations (A1-Al B1-Bm, C1-Cn, D1-Dp, E1-Eq) via the network, etc., and serves to have the communication area information distributed from the respective base stations (A1-Al, B1-Bm, C1-Cn, D1-Dp, E1-Eq). The communication area information providing server 100 is, e.g., an information processing terminal such as a personal computer, a workstation and so on.

The communication area information providing server 100 includes an internal or external storage device for managing and storing, on an area-by-area basis, the communication area information (the latest (updated) information unique to the communication area) about the communication areas of the respective base stations (A1-Al, B1-Bm, C1-Cn, D1-Dp, E1-Eq).

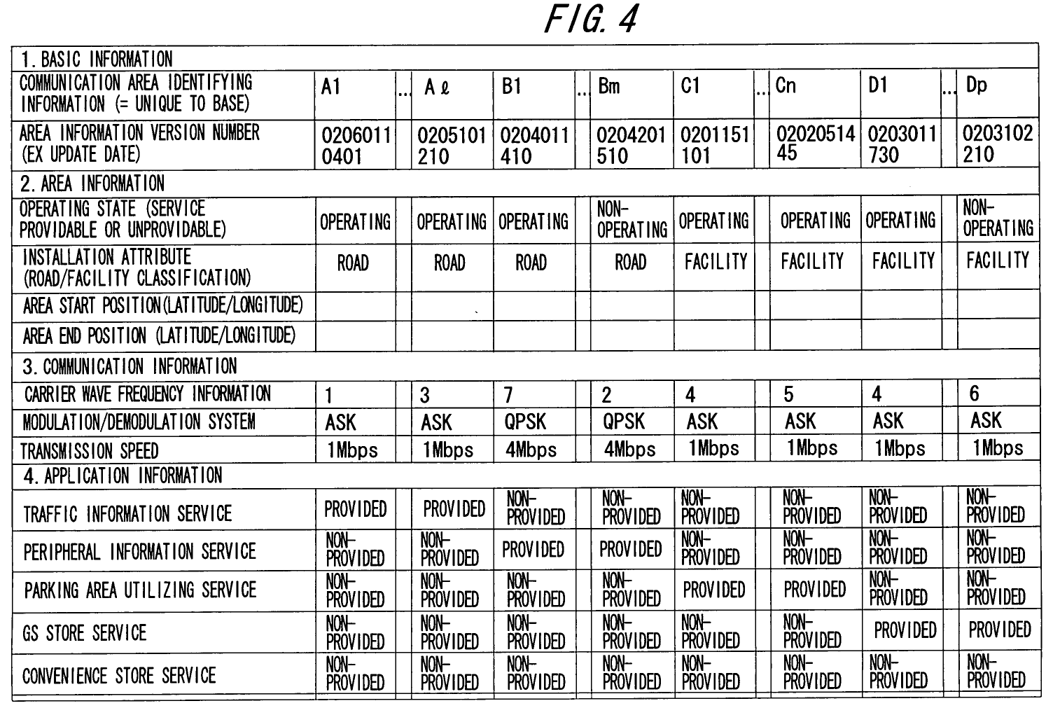

FIG. 4 is an explanatory diagram showing an example of the communication area information.

As shown in FIG. 4, the communication area information is the latest information unique to the communication area of each of the areas (A1′-Al′, B1′-Bm′, C1′-Cn′, D1′-Dp′, E1′-Eq′). These pieces of communication area information are always updated into the latest information by a manual input of an operator, etc. or by an automatic input, etc. from the information processing terminal such as an external server, etc. Note that it can be judged from an area information version number whether the information is the latest or not.

The communication area information consists of basic information, area information, communication information and application information.

The basic information has items (fields) such as communication area identifying information, an area information version number, etc. Information unique to the base station, which serves to identify the communication area of each base station, is set (or registered) in the communication area identifying information. Information showing how much new or old the communication area information corresponding thereto is, e.g., a date/time of the update, is set in the area information version number.

The area information has items such as an operating state, an installation attribute, an area start position, an area end position, etc. Information showing an operating situation (showing whether the service is providable or not, and so on) of the base station corresponding thereto, e.g., operating or non-operating, is set in the operating state. Set in the installation attribute is information showing an installation location of the base station corresponding thereto, e.g., a road or a facility. Set in the area start position is information showing a start position of the communication area of the base station corresponding thereto, e.g., latitude and longitude. Set in the area end position is information showing an end position of the communication area of the base station corresponding thereto, e.g., the latitude and the longitude.

The communication information has items such as carrier wave frequency information, a modulation/demodulation system, a transmission speed, etc. Information for specifying a carrier wave frequency (channel) of the base station corresponding thereto, is set in the carrier wave frequency information. Information for specifying a modulation/demodulation system of the data distributed from the base station corresponding thereto, is set in the modulation/demodulation system. Information for specifying a transmission speed of the data distributed from the base station corresponding thereto, is set in the transmission speed.

The application information has items such as a traffic information service, a peripheral information service, a parking area utilizing service, a GS store service, a convenience store service, etc. These items serve to identify the services (the data about the predetermined services) provided by the corresponding base stations. For instance, [provided] is set in the traffic information service corresponding to the base station A1. This indicates that the base station A1 provides the traffic information service. While on the other hand, [non-provided] is set in the traffic information service corresponding to the base station B1. This indicates that the base station B1 does not provide the traffic information service.

The mobile terminal 200 serves to receive the predetermined data (the data about the predetermined services, the communication area information, etc.) distributed from the respective base stations (A1-Al, B1-Bm, C1-Cn, D1-Dp, E1-Eq) in accordance with a self-position (present position), and to execute a variety of processes (a start or a stop of the application, and so on) based on the predetermined data. The mobile terminal 200 is, for example, a general-purpose on-vehicle device mounted on a vehicle.

The mobile terminal 200 includes a CPU 201 that controls the whole operation thereof, and a wireless communication unit 202, a storage unit 203, a control unit 204, a position detection unit 205, an input unit 206, an HMI (Human Machine Interface) unit 207, a memory 208, etc., which are connected via a bus, etc. to this CPU 201.

The wireless communication unit 202 serves to perform the data communications with the respective base stations, and involves using a wireless communication device that can support ASK • 1 Mbps and QPSK ∩ 4 Mbps in this embodiment.

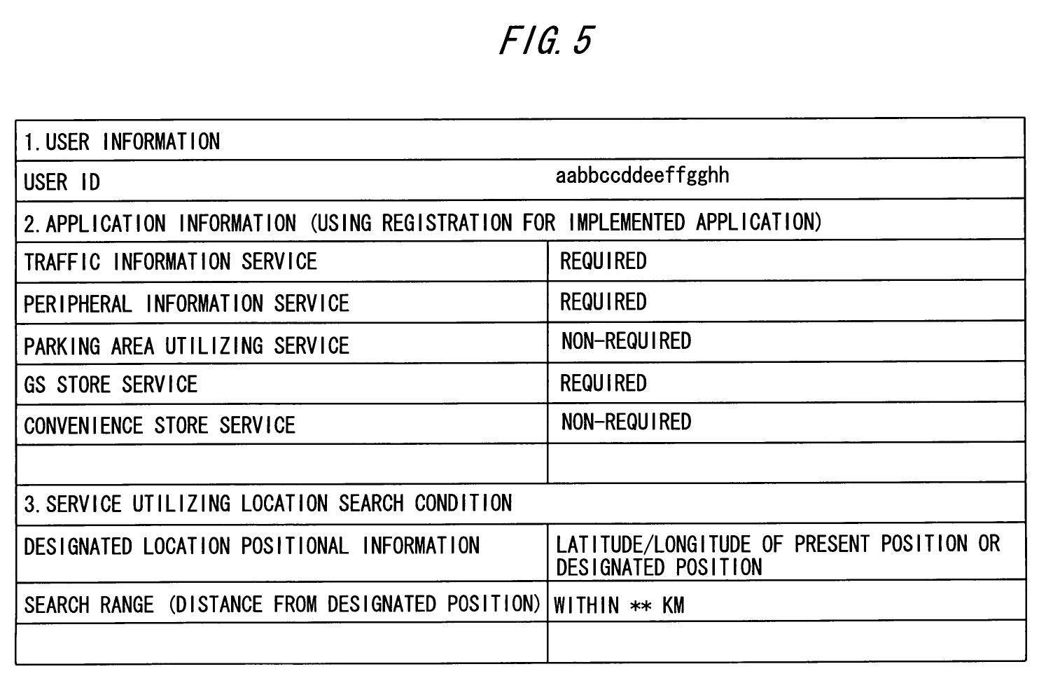

The storage unit 203 serves to store a predetermined OS (Operating System), a plurality of programs (programs, etc. for utilizing the respective applications) executed on the OS, the communication area information (see FIG. 4), user information (see FIG. 5), electronic map information and so on. The storage unit 203 is, e.g., a readable/writable storage device such as a hard disk device, a flash memory, etc. Incidentally, as for the map information, if a car navigation system is mounted on the mobile terminal 200, the map information of this car navigation system can be shared.

FIG. 5 is an explanatory diagram showing an example of the user information.

As shown in FIG. 5, the user information consists of user information, application information and service utilizing location search conditions. These categories of information are inputted by the user from, e.g., the input unit 206.

A user ID (identifying information) for identifying the user is set in the user information. The application information has items such as the traffic information service, the peripheral information service, and the parking area utilizing service and the convenience store service. These items are used for identifying the services that the user considers to utilize. For instance, [non-required] is set in the parking area utilizing service and in the convenience store service, which indicates that the user does not consider to utilize these services. While on the other hand, [required] is set in the traffic information service, the peripheral information service and the GS store service, which indicates that the user considers to utilize these services.

The service utilizing location search conditions contain designated location positional information and a search range. Latitude and longitude of the present position or the designated position are set in the designated location positional information. A distance from the designated position is set in the search range.

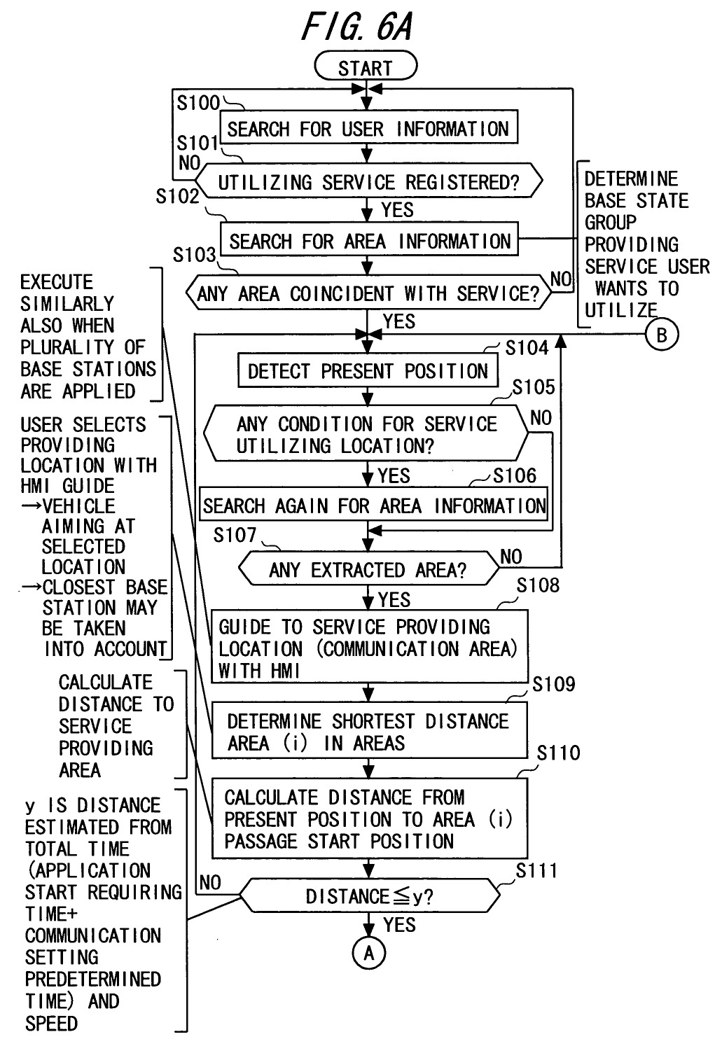

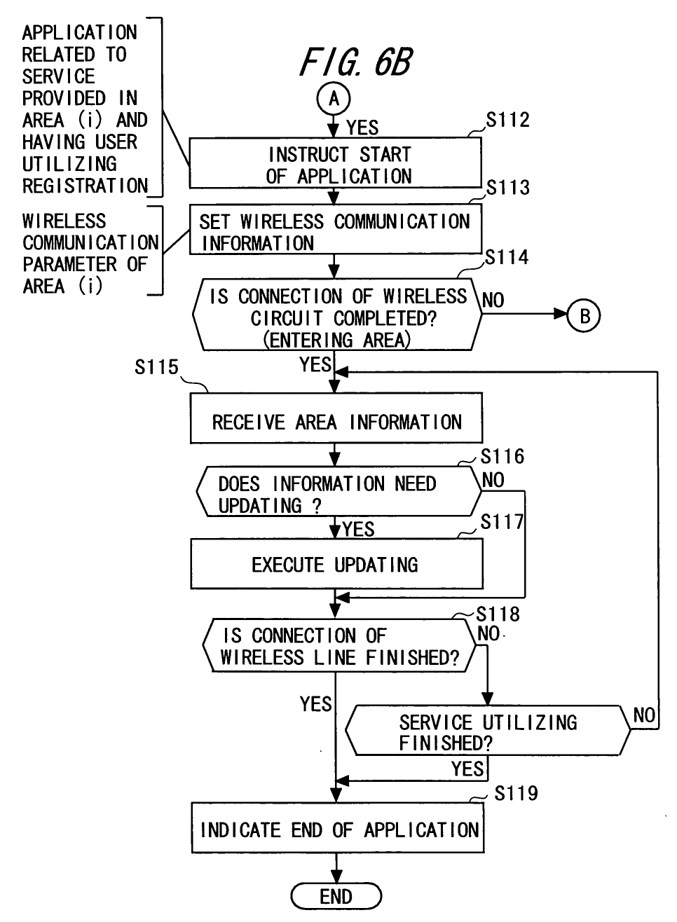

The control processing unit 204 serves mainly to execute processes shown in FIGS. 6A and 6B. The control processing unit 204 is actualized such that a predetermined program is read (into the memory 208) from the storage unit 203 and is executed by the CPU 201.

The position detection unit 205 serves to detect the present position of the mobile terminal 200 (or the vehicle mounted with the mobile terminal 200), and includes, e.g., a GPS (Global Positioning System) receiver, etc.

The input unit 206 serves to input and change the user information and to input other categories of various commands or information and is, for example, a voice recognition device for inputting voices and an input device based on a key manipulation of a key set, etc.

The HMI unit 207 serves to indicate a location of the communication area, the area information, etc. on a screen and in voice. The HMI unit 207 includes, e.g., an output unit of an image display device such as a liquid crystal display, a CRT display, etc., and an output unit of a voice output device, etc. such as a loudspeaker, and so on.

Next, an operation of the wireless communication system having the aforementioned architecture will be explained with reference to the drawings. FIG. 6 is an explanatory flowchart of the operation of the wireless communication system in the present embodiment.

The following discussion deals with an example of the operation in such a case that a vehicle V mounted with the mobile terminal 200 moves, as shown in FIGS. 2 and 3, from a position P0 to a position P1.

In the following explanation, the communication area information providing server 100 distributes, as the peripheral information, the communication area information about communication areas in the vicinity of the communication area of the base station (a distribution source base station) from the respective base stations (A1-Al, B1-Bm, C1-Cn, D1-Dp, E1-Eq). For instance, the communication area information providing server 100 distributes, as the peripheral information, the communication area information about the communication areas B1′, C1′, D1 and E1′ in the vicinity of the communication area A1′ of the base station A1 (the distribution source base station) from the base station A1 shown in FIG. 3. For distributing the peripheral information, the communication area information providing server 100 retains such data that the communication area (e.g., the communication area A′) of the distribution source base station (e.g., the base station A) is associated with the communication areas (e.g., the communication areas B1′, C1′, D1′ and E1′) in the vicinity of A′. Accordingly, the communication area information providing server 100 can distinguish the communication area of the base station (the distribution source base station) and the vicinal communication areas thereof, and can distribute from the base station the communication area information about the communication areas vicinal to the communication area of the base station.

As shown in FIG. 3, the base station A1 provides the communication area A1′ on a route extending from the position P0 to the position P1. The base station A1 provides, as described above, the traffic information providing service (the data, etc. about the traffic information) and the communication area information (the peripheral information) for the purpose of their being received by the mobile terminal 200 residing in this communication area A1′. Further, as shown in FIG. 5, the mobile terminal 200 retains the user information in which [required] is set in the traffic information service.

Accordingly, when the vehicle V is located within the communication area A1 halfway to the position P1 from the position P0, the mobile terminal 200 receives the traffic information providing service (the data, etc. about the traffic information) and the communication area information (the peripheral information). The communication area information (the peripheral information) is the communication area information about the communication areas B1′, C1′, D1′ and E1′ in the vicinity of the communication area A1′ of the base station A1 (the distribution source base station). These pieces of receipt information are stored on the storage unit 203 of the terminal 200 itself.

Note that the mobile terminal 200, when the self storage unit 203 has already been stored with the communication area information (pieces of area information B1′, C1′, D1′ and E1′) received in the communication area A1′, updates these pieces of information into the latest information and thus stores the updated information. To be specific, the control unit 204 compares the received communication area information (the area identifying information and the information version number) with the already-stored communication area information (the area identifying information and the information version number). Then, the control unit 204, when judging from a result of the comparison that these pieces of received communication area information are the latest information, stores (e.g., overwrites) the received communication area information. With this contrivance, even when a large number of various communication areas (the base stations) exist in dispersion and even when the number of areas increases or decreases in the respective locations or contents of the services and the operating state are changed as occasion demands, the user can be notified of the latest position of the communication area and of the latest content of the service. At this point of time, the storage unit 203 of the mobile terminal 200 is to be stored with the communication area information shown in FIG. 4.

(Peripheral Area Search Process)

Next, an operation after the vehicle V has passed through the communication area A1′ will be explained with reference to FIG. 6. The following process is a process for searching for a peripheral area in which to provide a service the user considers to utilize and for notifying the user of this peripheral area.

The control unit 204, when the vehicle V passes through the communication area A1′, refers to the user information stored on the storage unit 203 and thus searches for the service that the user considers to utilize (S100). Herein, the search target services as such are the traffic information service, the peripheral information service and the GS service showing the setting of [required] in the user information (the application information) (see FIG. 5) (S101: Yes).

Next, the control unit 204 refers to the communication area information (containing the communication area information after being updated) stored on the storage unit 203, thereby searching for the communication areas in which to provide the services (the traffic information service, the peripheral information service and the GS service) retrieved in S101 as the services that the user considers to utilize (S102). Herein, the communication areas A1, Al, B1, Bm, D1 and Dp are retrieved as these communication areas (see FIG. 4) (S103: Yes).

Next, the control unit 204 judges whether or not the service utilizing location search conditions are set as the user information (S105) Herein, as shown in FIG. 5, the service utilizing location search conditions are registered as the user information (S105: Yes), and hence the control unit 204 searches again for (selects) the communication areas conforming with those search conditions among the communication areas A1, Al, B1, Bm, D1 and Dp retrieved in S102 on the basis of the present position detected by the position detecting unit 205 in S104 (or read from the position detecting unit 205) and the service utilizing location search conditions shown in FIG. 5 (S106).

For example, the control unit 204, when the latitude and the longitude of the present position are set in the user information (the designated location positional information), searches again for the communication areas existing within the range set in the user information (the search range) from that present position. It is herein assumed that the communication areas B1, D1 are extracted as a search result. Note that when the latitude and the longitude of the present position are set in the user information (the designated location positional information), there are retrieved again the communication areas existing within the range set in the user information (the search range) from that designated position.

The control unit 204, when the communication areas B1, D1 conforming with the search conditions are extracted (S107: Yes), notifies the user of the locations of those extracted communication areas B1, D1 and guides the user to those areas through the HMI unit 207 (S108). For example, the voices for guiding the user to those locations are outputted from the on-vehicle loudspeaker, etc. Alternatively, those locations are displayed on the display screen (e.g., a map screen) of the liquid crystal display, etc.

As a result, the user can know where the peripheral information service providing area B1 and the GS service providing area D1 exist as neighboring areas, and can travel toward those areas.

(Start Process, etc. of Application Program) Given next is an explanation of a process of starting up the applications that should be used (required) in those areas before reaching the retrieved-and-notified peripheral areas.

The control unit 204 determines the communication area located at a shortest distance from the present position in the communication areas B1, D1 extracted in S106 (S109). Specifically, the communication area located at the shortest distance as a linear (direct) distance from the present position is determined. Alternatively, a search for a route extending from the present position up to each of the communication areas B1, D1 extracted in S106 is made, and the communication area exhibiting the shorter outreach distance is determined. In the present embodiment, even when taking any determination method, as obvious from FIG. 3, etc., the communication area B1 is determined as the communication area located at the shortest distance from the present position.

The control unit 204, when the communication area B1 located at the shortest distance is determined, calculates a distance between the present position and the communication area B1 (an area start position) (S110). Then, the control unit 204 compares arrival required time (remaining distance/car speed, etc.) for arriving at the communication area B1 with y (time estimated from start-up required time of the application program, wireless unit setting required time and a speed) (S111: No, S104 through S111).

The control unit 204, at a point of time when the arrival required time to the communication area B1 is less than y (S111: Yes), starts up the application program that should be used (required) in the communication area B1 (S112). To be specific, the control unit 204 refers to the communication area information stored on the storage unit 203, thereby determining the application program that should be used in the communication area B1. Then, the control unit 204 starts up the thus-determined application program.

For determining and starting up this application program, the mobile terminal 200 retains such data that the respective communication areas are associated with pieces of data designating the application programs that should be started up in the communication areas. These items correspond to, for instance, the communication area identifying information and the application information shown in FIG. 4. In FIG. 4, among pieces of application information associated with the communication area B1, the setting of [required] is entered in the peripheral information service. This indicates that the application program that should be started up in the communication area B1 is the application program for utilizing the peripheral information service. Accordingly, the control unit 204 judges, by referring to the communication area information stored on the storage unit 203, that the application program that should be started up in the communication area B1 is the application program for utilizing the peripheral information service, and can start up this program.

Next, the control unit 204 determines the communication information (QPSK • 4 M, CH7) that should be used in the communication area B1 by referring to the communication area information stored on the storage unit 203, and sets the determined information in the wireless communication unit 202 (notifies the unit 202 of the information) (S113).

For this setting, the mobile terminal 200 retains such data that the respective communication areas are associated with the communication information that should be set in these communication areas. These items correspond to, for example, the communication area identifying information and the communication information shown in FIG. 4. In FIG. 4, QPSK • 4 M and CH7 are set as the communication information associated with the communication area B1. This indicates that the communication information (i.e., the communication information that should be set in the wireless communication unit 202) that should be used in the communication area B1, is QPSK • 4 M and CH7. Accordingly, the control unit 204 can judge that the communication information that should be used in the communication area B1 is QPSK • 4M and CH7 by referring to the communication area information stored on the storage unit 203, and can set the communication information in the wireless communication unit 202.

This enables the mobile terminal 200 to execute beforehand the processes (the start-up of the application program and the setting of the communication information) for utilizing the service provided from within the communication area B1′ before reaching the communication area B1′. Further, even when the wireless line is diversified (an increase in channel of frequency), it is possible to properly select or designate the wireless line.

The base station B1, as described above, provides (distributes) the peripheral information service (the data, etc. about the peripheral information) supplied from the peripheral information providing server S2 and the communication area information (the peripheral information) supplied from the communication area information providing server 100 for the purpose of their being received by the mobile terminal 200 residing in this communication area B1′. Further, as shown in FIG. 5, the mobile terminal 200 retains the user information in which [required] is set in the peripheral information service.

Accordingly, when the vehicle V is located in (enters) the communication area B1′ (S114: Yes), the mobile terminal 200 promptly receives the receipt signals (the peripheral information service (the data, etc. about the peripheral information)) and the communication area information (the peripheral information) which are provided from the base station B1 (S115). These pieces of receipt information are stored on the storage unit 203 of the terminal 200 itself. This enables the utilization of the peripheral information service based on the application program started up a short while ago on the mobile terminal 200.

Note that the mobile terminal 200, if the communication area information received in the communication area B1′ has already been stored on the self storage unit 203, updates the communication area information into the latest information and then stores this updated information. Specifically, the control unit 204 compares these pieces of received communication area information (the area identifying information and the information version number) with the already-stored communication area information (the area identifying information and the information version number), thereby judging whether the received communication area information is the latest information or not (S116). Then, the control unit 204, when judging from a result of the comparison that the received communication area information is the latest information, stores (e.g., overwrites) the received communication area information (S117).

(Finishing Process of Application Program)

Next, a process of finishing (stopping) the application program started up a short while ago, will be explained.

The control unit 204 compares the present position detected sequentially by position detection unit 205 with an area end position of the communication area B1′ (S118). Then, the control unit 204, when judging from a result of the comparison that the vehicle V has passed through the communication area B1′ (S118: Yes), stops the application program (i.e., the application program for utilizing the peripheral information service in the communication area B1′) started up a short while ago (S119). For example, an area on the memory 208 into which the application program has been read, is set unoccupied. On the other hand, the control unit 204, when judging from the result of the comparison that the vehicle V does not yet pass through the communication area B1′ (S118: No) and judging the service utilization not to be finished (S120: No), repeats the processes from S115 through S118. Then, the control unit 204, when judging that the vehicle V does not yet pass through the communication area B1′ (S118: No) and judging the service utilization to be finished (S120: Yes), stops the application program (i.e., the application program for utilizing the peripheral information service in the communication area B1′) started up a short while ago (S119). For instance, the area on the memory 208 into which the application program has been read, is set unoccupied.

As discussed above, according to the wireless communication system in the present embodiment, the application that should be executed in the communication area can be started up before arriving at the communication area, and besides, when passing through this communication area (i.e., before reaching the next communication area), the application program started up a short while ago can be stopped. It is therefore possible to prevent the memory area from being invaded (eaten) by the cumulative start-up of the applications that is done whenever reaching the communication area. Hence, the wireless communication system in the present embodiment can be actualized by implementing the memory having the smaller capacity into the mobile terminal.

(Modified Example)

Next, a modified example of the embodiment discussed above will be described.

The embodiment described above has given the exemplification that the communication area information providing server 100 distributes the communication area information about the communication areas in the vicinity of the communication area of the base station (the distribution source base station) from each of the base stations (A1-Al, B1-Bm, C1-Cn, D1-Dp, E1-Eq), however, the present invention is not limited to this exemplification.

For example, the communication area information providing server 100 may distribute, from each of the base stations (A1-Al, B1-Bm, C1-Cn, D1-Dp, E1-Eq), the communication area information about the communication areas of other base stations for providing the same category of service. For example, the communication area information providing server 100 may distribute, from the base station shown in FIG. 3, the communication area information about the communication areas (A2′, A3′, . . . A1′) of other base stations (A2, A3, . . . A1) for providing the same category of service. For attaining this distribution, the communication area information providing server 100 retains such data that the distribution source base station (e.g., the base station A) is associated with the communication areas (e.g., A2, A3, . . . A1) of the base stations for providing the same category of service. With this contrivance, the distribution described above can be attained. Other processes are the same as those in S100 through S120 explained with reference to FIG. 6, and hence their explanations are omitted.

Further, the embodiment discussed above has given the exemplification that the communication area information providing server 100 distribute, automatically (irrespective of whether or not the request is given from the user, etc.) from each of the base stations (A1-Al, B1-Bm, C1-Cn, D1-Dp, E1-Eq), the communication area information about the communication areas in the vicinity of the communication area of the base station (the distribution source base station), however, the present invention is not limited to this exemplification.

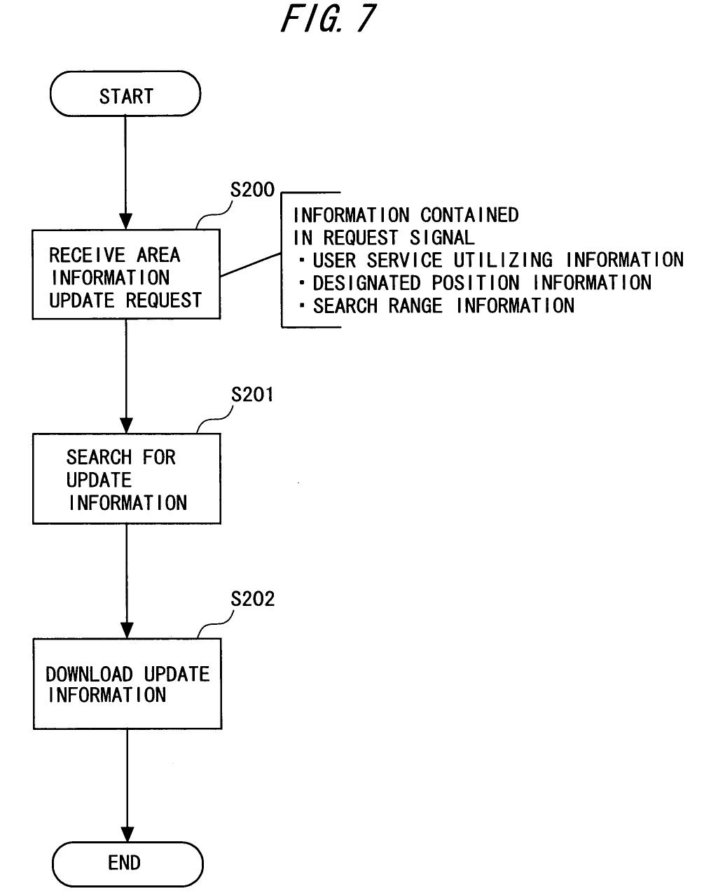

For instance, the communication area information providing server 100 may provide the communication area information about the communication area that is requested from the mobile terminal 200. The following is a specific operation. For example, as shown in FIG. 7, the mobile terminal 200 is made to input a communication area information update request (Request) from its input unit 206, and transmits this request to the communication area providing server 100 via the base station. The communication area information update requests are utilizing server information for designating the service that the user considers to utilize, the present position (or a user designated position) and a search range (e.g., a distance) from the present position (or the user designated position). The communication area information providing server 100, when receiving the communication area information update request (S200), searched for the communication area information (e.g., the communication area information about the communication area within a district corresponding to the user designated position) conforming with the request from within the communication area information of the server 100 itself (S201), and provides the searched communication area information to the mobile terminal 200 as a requester via the base station (S202). Other processes are the same as those in S100 through S120 explained with reference to FIG. 6, and hence their descriptions are omitted.

The present invention can be carried out in a variety of forms without deviating from the sprit and the principal features thereof. Therefore, the embodiment discussed above is nothing but the simple exemplification in every aspect and should not be construed limitedly.

Industrial Applicability

As discussed above, according to the present invention, the resources can be efficiently used. Further, the user can search for the area for providing the want-to-utilize service from within the communication areas diversified and existing in dispersion and can utilize the service by use of the mobile terminal such as the general-purpose on-vehicle device, etc. Moreover, the DSRC multi-application system having the high usability can be actualized.

1. A wireless communication system including a plurality of base stations for wirelessly distributing predetermined data for the purpose of being received by a mobile terminal located within a communication area of the system itself, comprising:
a management unit managing communication area information about communication areas of said respective base stations;
a communication area information providing server distributing the communication area information via each of said base stations; and
a mobile terminal having a wireless communication unit for receiving the communication area information distributed from each of said base stations in accordance with a self-position, and starting up an application program that should be used in the communication area that said mobile terminal itself approaches based on the received communication area information.

2. A wireless communication system according to claim 1, wherein said mobile terminal starts up the application program before arriving at the communication area that said mobile terminal itself approaches.

3. A wireless communication system according to claim 1, wherein said mobile terminal sets, in said wireless communication unit, a communication parameter that should be used in the communication area said mobile terminal itself approaches.

4. A wireless communication system according to claim 3, wherein said mobile terminal sets the communication parameter before arriving at the communication area that said mobile terminal itself approaches.

5. A wireless communication system according to claim 1, wherein said mobile terminal stops the running application.

6. A wireless communication system according to claim 1, wherein said communication area information providing server distributes the communication area information about at least the communication areas in the vicinity of the communication area of a distribution source base station, distributed from each of said base stations.

7. A wireless communication system according to claim 1, wherein said communication area information providing server distributes the communication area information about at least the communication areas of base stations for providing the same category of service, distributed from each of said base stations.

8. A wireless communication system according to claim 1, wherein said communication area information providing server distributes the communication area information about at least the communication area within a district corresponding to a user designated position, distributed from each of said base stations.

9. A mobile terminal included in a wireless communication system including a plurality of base stations for wirelessly distributing predetermined data for the purpose of being received by a mobile terminal located within a communication area of the system itself, comprising:
a wireless communication unit receiving communication area information distributed from each of said base stations in accordance with a self-position;
a storage unit storing the communication area information received by said wireless communication unit;
a determining unit determining an application program that should be used in the communication area that said mobile terminal itself approaches based on the communication area information stored on said storage unit; and
a program starting unit starting up the application program determined by said determining unit.

10. A mobile terminal according to claim 9, wherein said program staring unit starts up the application program before arriving at the communication area that said mobile terminal itself approaches.

11. A mobile terminal according to claim 9, further comprising a setting unit for setting, in said wireless communication unit, a communication parameter that should be used in the communication area that said mobile terminal itself approaches.

12. A mobile terminal according to claim 11, wherein said setting unit sets the communication parameter before arriving at the communication area that said mobile terminal itself approaches.

13. A communication area information providing server included in a wireless communication system including a plurality of base stations for wirelessly distributing predetermined data for the purpose of being received by a mobile terminal located within a communication area of the system itself, comprising:
a management unit managing communication area information about communication areas of said respective base stations; and
a distributing unit distributing the communication area information via each of said base stations.
